(19) United States
(12) Patent Application Publication
(10) Pub. No.: US 2013/0008033 A1
(43) Pub. Date: Jan. 10, 2013

(54) Multifunctional Gardening Tool

(76) Inventor: Louis Fortman, New Freedom, PA (US)

(21) Appl. No.: 13/342,647

(22) Filed: Jan. 3, 2012

Related U.S. Application Data
(60) Provisional application No. 61/505,302, filed on Jul. 7, 2011.

(51) Int. Cl. A01D 11/00

(52) U.S. Cl. 30/278

(57) ABSTRACT

A multifunctional gardening tool that enables a user to mulch, weed and trim a garden, while also allowing the user to easily remove sod or grass using a single tool. The device comprises a handle, either hand held or elongated, along with a working end having a pentagonal shaped cutting tool. The gripping end of the handle is covered with a soft material to improve a user's grip, while the working end of the device comprises a cutting tool with a top portion that attaches to the handle, two parallel, vertical cutting edges and a protruding V-shaped blade constituting the bottom edges of the blade. Teeth on the V-shaped blade, in conjunction with the two vertical cutting edges of the blade, enable the device to cut through roots, sod and other obstacles typically encountered when working in a garden or yard.

### CROSS REFERENCE TO RELATED APPLICATION

This application claims the benefit of U.S. Provisional Application No. 61/505,302 filed on Jul. 7, 2011, entitled “3-in-1 Yard Tamer.”

### BACKGROUND OF THE INVENTION

1. Field of the Invention

The present invention relates to a gardening tool having a working end that provides multiple gardening functionalities. More specifically, the present invention relates to a gardening tool with a utility blade working end that attaches to a user handle. The blade serves a variety of cutting functions, such as cutting through plant roots while working in the soil, edging plant beds, cutting strips of sod and cutting back overgrowth of vegetation encountered during maintenance of a garden or yard. Having a single device that serves a variety of gardening functions reduces the need to buy and store a plurality of single-function gardening tools while engaging in gardening or landscaping activities.

2. Description of the Prior Art

Gardening and landscaping are both popular activities that many individuals may derive pleasure or satisfaction from. Individuals may find gardening to be therapeutic, relaxing or a personally gratifying experience. Traditional gardeners aim to cultivate plants as a supplemental food source or for aesthetic purposes, orienting their plants in classical configurations such as vegetable patches, rose gardens or herb gardens. That is not to say that all gardening is highly compartmentalized, with each garden variety necessarily existing as its own individual, stand-alone garden. Some gardeners prefer an integrated gardening area. For some, gardening is a creative outlet and a means of home or yard beautification. Alternatively, some individuals are focused entirely on keeping a well manicured yard. For these individuals, having a well-kept yard results in a sense of pride.

Creating and maintaining a planted area requires the use of many different tools, some of which can be expensive to procure and a challenge to store. A gardener may need to use a shovel or spade for digging, a hoe or trowel for weeding, and a rake for spreading mulch or fertilizer. The single-purpose nature of such gardening tools can be inconvenient, as a gardener must switch tools often while working in a planted area, which can be frustrating for a gardener, especially in the event that he or she has misplaced one of the various tools. The gardener must purchase all the different gardening tools and, consequently, must also locate storage for the plurality of gardening tools. There is a need for a single, multifunctional gardening tool which thereby enables a user to complete multiple gardening tasks without having to switch gardening tools. Such a device is more affordable than purchasing multiple, single-function gardening tools, and is further more convenient to store.

The present invention is gardening tool that enables a user to perform a variety of gardening tasks with the same tool. The device comprises a gripping end with a handle, either hand held or elongated, and a working end having an attached pentagonal shaped cutting blade. The gripping end of the handle is covered with a soft material to improve a user's grip on the device, while the working end of the device comprises a cutting tool having a top portion that attaches to the handle of the device, two parallel, vertical cutting edges and a protruding V-shaped blade constituting the bottom edges of the blade. A set of serrated teeth exist on the V-shaped blade. The teeth, in conjunction with the two vertical cutting edges of the blade, enable the device to cut through roots, sod and other obstacles typically encountered when working in a garden or yard.

Various patents exist for digging and scooping devices. For example, U.S. Pat. No. 6,234,549 to Brownell describes a cat litter scooper tool. The device is a hand held scooper with a handle end and a scooping basket end for collecting and removing wet clumps of cat excrement or urine from a litter box. The device consists of a metal scooping blade, and a plastic scooper basket and handle. The scooping blade of the device exists in two distinct embodiments in which the scooping blade of the device is either planar or triangular shaped. These particular configurations of the scooping blade of the device enable a user to guide the scooping edge of the device to the wall or corner of the litter box. It is undesirable for a user to touch a wet cat litter clump and utilizing the wall or corner of the litter box to help push the wet clump into the scooper is an ideal solution. Once the clump is on the scooper, the user will tilt the device back, such that the scooper basket is tilted upwards and the handle of the device is tilted downwards, thereby enabling the wet clump to slide further into the scooper basket. The wet clump contents of the scooper basket may then be discarded into a waste receptacle.

While the Brownell device may be capable of scooping up soil, the device is intended for use scooping cat litter. Cat litter is an easy substance to manipulate and work with; it is light weight, easily siftable and, with the exception of wet clumps after a cat uses the litter box, cat litter does not present any obstacles that may interfere with the scooping of the litter. Conversely, while working in soil, gardeners encounter numerous roots, rocks and other debris, which may interfere with any digging or other manipulations of the soil that a gardener is attempting to accomplish. The present invention is intended for use in soil. The present invention is equipped with a blade for cutting through tough roots and undesirable vegetation. The shape and construction of the blade provides a durable and effective tool that can withstand damage from incidental impact with rocks that may be hidden in the soil that occurs during use, while allowing the user to cut through dense soil and vegetation. The interior of the present invention cutting blade is hollow to allow soil to flow through the device as it cuts through articles in the soil, while the Brownell device provides a continuous, shovel-like device for scooping and removal.

Similar to the Brownell device is U.S. Pat. No. 1,427,523 to Doyle describing a scooper or shovel device having a handle end opposite a scooper basket end. The device incorporates a woven wire mesh as the bottom of the scooper basket end of the device for the purpose of allowing scooped up ashes to fall through the open spaces of the mesh when sifting through fireplace ashes in search of reusable remnants of coal. The device can exist as a large shovel-sized version of the device or a hand held scooper version of the device. The scooping edge of the scooper basket can be equipped with teeth, which project away from the scooper basket. While effective for its intended requirements, the Doyle device differs considerably with respect to the present invention. The Doyle device provides cutting teeth at the distal end of the tool, and in a design that diverges from that of the present invention.

U.S. Pat. No. 1,564,720 to Surbaugh also describes a unique shovel and scoop blade design. The Surbaugh device has a scoop blade edge, two side edges, a handle attaching edge opposite the scoop blade edge, a bottom to the scooper basket and an open top of the scooper basket. The scoop and blade are stamped from a single piece of sheet metal and the handle attaching edge of the scooper is pressed so that a divot is formed centrally on the bottom of the scooper basket, extending to the handle attaching edge of the scooper. The divot is intended to receive a handle. The Surbaugh device provides a unique shovel tool; however its structural elements differ from that of the present invention, wherein a pentagonal-shaped cutting implement with a hollow interior region is provided for manipulating soil in and around vegetation. The Surbaugh device is more suited for lifting and removing large quantities of material, and providing a sharpened shovel for breaking through dense material prior to scooping.

Regarding multifunctional gardening tools, U.S. Pat. No. 5,765,648 to Sheehan describes a multifunctional gardening hand tool for use in applications such as gardening, planting and soil working. The device is a dish-shaped scooping blade attached to a short handle. The blade is a contoured scooping dish, having two upstanding edges and a pointed end opposite a handle attachment. The pointed tip of the blade serves a variety of functions such as scraping, picking, prying, digging, furrowing, scooping and excavating soil. In one embodiment of the device, there are a plurality of serrated teeth located at the midsection of the two blade edges, which can be used for cutting plant roots under the soil that may be obstructing the device while in use digging.

The Sheehan device is useful when digging and working closely with soil. The curved dish-shaped scooping blade of the device is intended for the purpose of displacing soil and thus the Sheehan device is limited to use in only those applications where disrupting or transferring soil or mulch is desirable. The present invention is intended for use while gardening, and maintaining planted areas, incorporating an open digging blade such that soil or mulch may pass through the center of the blade during the digging or mulching action. For example, a gardener may have prepared a well-manicured planted area with mulch and decorative stones as finishing details. However, small weeds may begin growing up through the mulch. Rather than disrupt the mulch while removing weeds, which necessitates replacement of the mulch, the present invention allows for objects and material to pass through the center of the blade, removing unwanted vegetation that may be growing under a bed of mulch without disturbing the mulch, stones or other finishing details.

U.S. Pat. No. 5,406,709 to Stambaugh also describes a multipurpose gardening tool, which, in particular, serves as a sod cutter, soil loosening tool and root cutter. The device is a blade affixed to a handle. An attached blade is triangular in shape, forming a generally triangular shape, whereby the handle attaches to the blade immediately adjacent to the first edge of the triangle so as to extend away from the second edge substantially parallel to the first edge. The working edge of the blade incorporates a series of serrated cutting teeth for cutting through undesirable vegetation.

The Stambaugh device utilizes a single, triangular blade having serrations thereon. While useful for cutting unwanted vegetation, roots and sod, or edging a planted bed, use of the device requires disruption of the medium being worked with. Much like each of the prior art devices, which incorporate a scooper into the design of the device, use of such devices consequently disrupts the medium which it is intended to scoop. The singular blade is further not effective at removing layers of sod or grass in a scooping motion. Rather, the Stambaugh device is used for edging and sawing action. The blade on the working end of the present invention, alternatively, is shaped similar to an irregular pentagon and allows for objects and materials to pass through the center of the blade, leaving those objects or materials virtually undisturbed. The device further allows a user to uproot a patch of sod or grass, as the top soil and roots of the grass pass through the center of the device while in action. An individual may further insert the blade of the device under a mulch bed and perform a cutting or scuffing motion while moving the blade beneath the mulch bed. The device cuts the stems of weeds that may be growing up through the mulch and leaves the mulch, for the most part, undisturbed because the mulch passes through the open center of the blade as the device cuts weeds along the bed.

It is therefore submitted that the present invention substantially diverges in design elements from the prior art and consequently it is clear that there is a need in the art for an improvement to existing multipurpose gardening tool devices. In this regard the instant invention substantially fulfills these needs.

### SUMMARY OF THE INVENTION

In view of the foregoing disadvantages inherent in the known types of scooping and multifunctional gardening devices now present in the prior art, the present invention provides a new multifunctional gardening tool wherein the same can be utilized for providing the user with the convenience of using a single tool for a variety of gardening tasks.

It is therefore an object of the present invention to provide a new and improved multifunctional gardening tool device that has all of the advantages of the prior art and none of the disadvantages.

Another object of the present invention to provide a user with a single device that serves a plurality of purposes, saving the user the cost of having to purchase a series of single function tools and the hassle of storing a variety of gardening tools.

Another object of the present invention is to provide a device that has a cutting blade that allows for soil, mulch or cut sod to pass through the center of the blade such that the soil, mulch or cut sod remains effectively undisturbed during cutting and removal operations.

Another object of the present invention is to provide a tool cutting blade having a pentagonal, hollow blade with several cutting edges. The device may provide a user with an edger, a mulcher, weed remover, sod remover and swing blade.

Yet another object of the present invention is to provide a multifunctional device that is comfortable for an individual to grip and use for an extended period of time.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a frontal perspective view of the present invention attached to an elongated handle.

FIG. 2 is a magnified perspective view of the blade working end of the present invention depicting one embodiment and the blade connection to the handle of the device.

FIG. 3 is a perspective side view of the blade working end of the present invention in a horizontal position.

FIG. 4 is a perspective view of the present invention in use cutting and removing a patch of grass or sod.

### DETAILED DESCRIPTION OF THE INVENTION

Reference is made herein to the attached drawings. Like reference numerals are used throughout the drawings to depict like or similar elements of the multifunctional gardening tool. For the purposes of presenting a brief and clear description of the present invention, the preferred embodiment will be discussed whereby the device has an irregular pentagonal shaped blade for use gardening and general landscaping activities. The figures are intended for representative purposes only and should not be considered to be limiting in any respect.

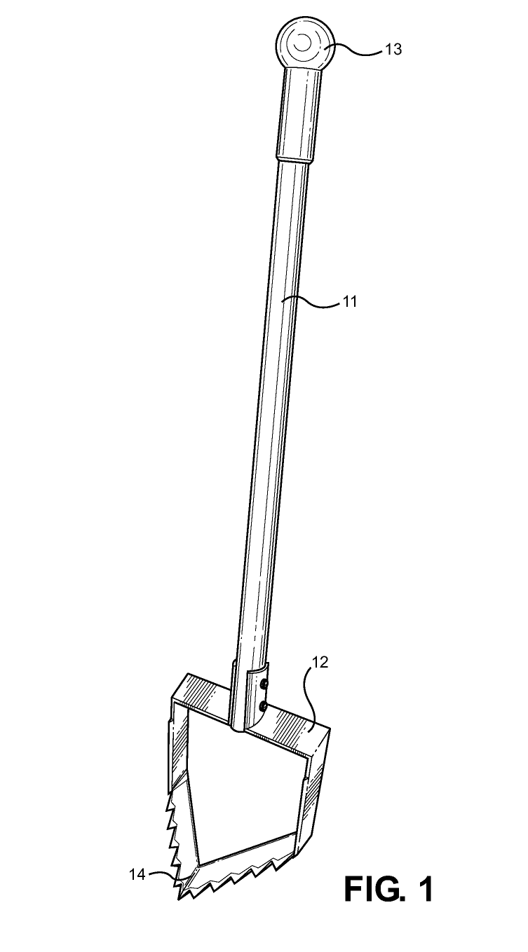

Referring now to FIG. 1, there is shown a perspective view of the present invention attached to an elongated handle 11 to allow a user to manipulate the tool while in an upright or standing posture. The present invention comprises a multifunctional garden maintenance tool having a utility blade 12 attached to a handle 11. The handle 11 of the device has two ends; a working end and a gripping end. The handle 11 maybe short, such that the device is hand held and can be used for smaller gardening applications requiring a high level of user dexterity and control when manipulating the device. The handle may alternatively be elongated such that an upright user may hold the device with two hands in a standing posture while using it. The handle 11 is preferably comprises of, but is not limited in composition to, wood, metal, fiberglass or plastic.

Located at the top of the gripping end of the handle 11, opposite the working end of the device, is a user grip 13. In addition to comfortably fitting the hand of a user, the purpose of the grip is to provide a place where a user exerts force on the device, gaining leverage over the device during use without causing unwanted pain or blisters to the user's hand. The grip 13 is covered in a thick, soft material—such as foam rubber or leather—for the purpose of enhancing the grippablity and comfort of the handle and to prevent harm that possibly occurs to the user as a result of using the present invention. The grip 13 may further comprise a gripping ball, which provides the user with greater surface area to grasp and a means to manipulate the end of the handle through rotation of his or her wrist while gripping the ball. Frequently during gardening, use of a tool for an extended period of time, which also requires the repeated performance of the same motion by a user, can cause blisters to form on the hands of a user. Such is a common occurrence when an individual rakes leaves or digs a hole with a shovel. The incorporation of a soft gripping material onto the gripping end of the present invention helps to prevent the formation of blisters on the hands of a user as he or she manipulates and works with the device.

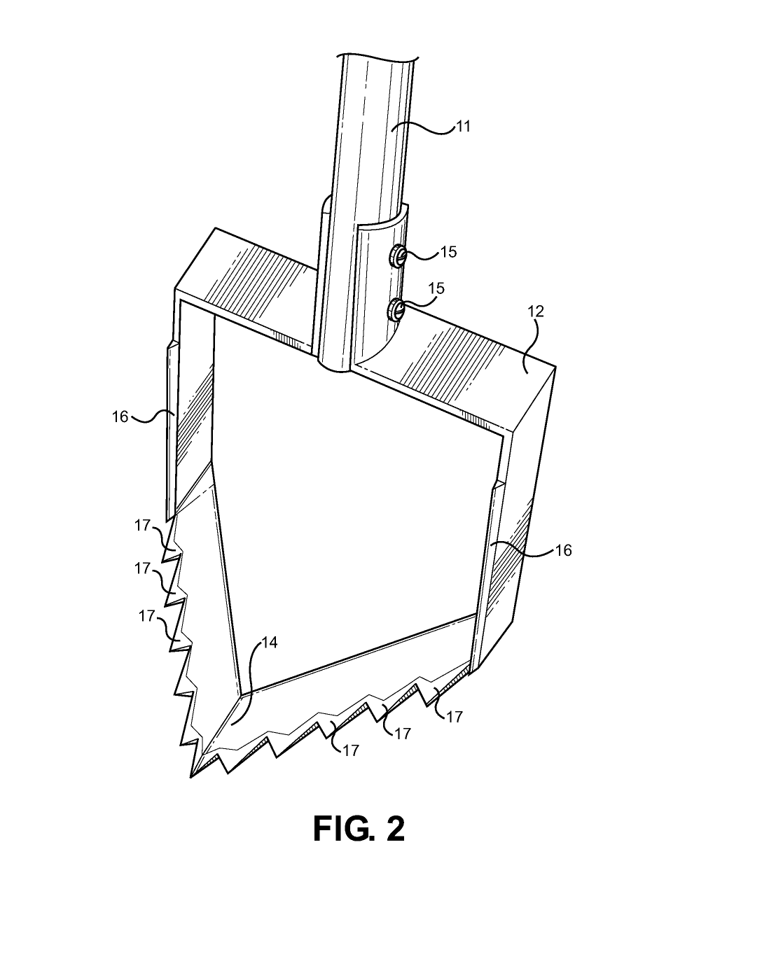

Referring now to FIG. 2, there is shown a perspective view of the working end of the present invention in more detail. In this particular embodiment of the present invention, a pentagonal-shaped cutting tool attaches to the handle 11 of the device by an attachment means 15. A pair of screws serves as the attachment means in this embodiment; however, the attachment means are not limited only to screws. The blade has defined parallel edges 16, an open interior space and a triangular distal end 14 that forms a point with serrated cutting edges extending therefrom. The blade geometry is symmetrical about an axis created by the handle, forming a first and second cutting edge 16 extending perpendicularly from a shelf 12 that flares outward from the handle. Extending out of plane and at an angle from the first and second cutting edges 16 are two converging cutting edges that form a V-shaped tip 14 to the tool and a pointed working end. The edges of the converging edges are preferably serrated to allow a cutting or sawing motion while in operation, furthering the ability of the device to cut through dense or heavily vegetated soil. The V-shaped blade protrudes outward into a three dimensional space from a plane in which the handle 11, blade shelf 12 and side edges 16 lie.

The teeth 17 of the V-shaped blade 14, in conjunction with the vertical cutting edges 16 of the device, are capable of cutting through roots and other undesirable vegetation. The device is used to dig in soil, create furrows, trowel weeds, and cut sod into easily removable strips. The shape of the working end of the device creates a space at its center whereby objects may pass therethrough, performing a task that is unsuited for traditional shovels or troughs. The ability of objects to pass through the center of the blade is desirable in certain situations. For example, an individual may desire to dig up a small plant. The user inserts the pointed tip of the working end of the device into the dirt near the roots of the plant. As the individual scoops under the plant, the device frees the roots of the plant from the soil. Above the soil, as the individual scoops the plant, the plant passes through the center space of the blade on the working end of the device.

While the particular embodiment of the present invention depicted in FIG. 2 features a working end having an irregular pentagon shaped blade, the overall shape of the working end of the present invention is not limited to a pentagon. Other variations of the blade shape can be used with the present invention. A triangle shaped blade having defined edges and an open interior space for materials and objects to pass therebetween may be a useful alternative embodiment of the present invention, wherein the side edges 16 are eliminated altogether. The formation of the V-shaped blade 14 and the shelf 12 provides an internally open region and a tool that fulfills a similar goal.

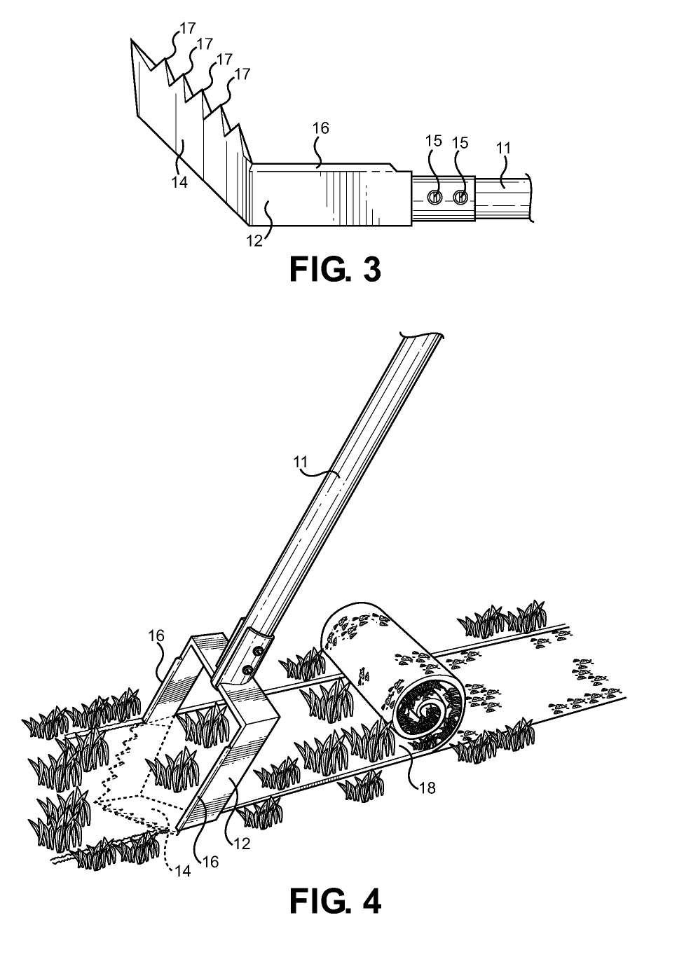

Referring now to FIG. 3, there is shown a side view of the working end of the present invention in a horizontal orientation. This angle illustrates how the V-shaped bottom portion of the blade protrudes outward from the device into a three dimensional space. The pointed tip of the V-shaped blade guides the device into the medium for which the user desires to work. The present invention is further equipped with a series of serrated teeth 17 and vertical cutting edges 16 that cut through tough roots and undesirable vegetation. The composition of the blade is desired to be a durable, high density material that can withstand damage from incidental impact with rocks hidden in the soil that occurs during use, and further allow for resharpening after extended periods of use.

Referring now to FIG. 4, there is shown a perspective view of the present invention in use cutting a strip of sod for removal. In some instances, it is desirable to remove a strip of sod 18 from the soil 19 and to replace the sod with planted flowers or other plants. To use the present invention for cutting strips of sod, a user guides the pointed tip of the V-shaped segment of the blade 14 into the sod until the entirety of the V-shaped segment 14 is under the sod's root mat. Using a sawing or scuffing motion, a user guides the device thereunder, thereby causing the V-shaped segment of the blade 14 and the vertical cutting edges 16 of the blade to cut the sod into a strip 18. The root structure of sod only penetrates a short distance into the soil, forming a root mat. The V-shaped segment of blade 14 cuts under the root mat of the sod strip 18 while the vertical cutting edges 16 cuts through the sod forming a strip of sod that passes therebetween the vertical cutting edges 16 and through the center of the irregular pentagon shaped blade. The roots of the sod or grass are preserved within a layer of top soil defined by the depth of the blade, which can then be removed in strips and sold or discarded. A user rolls the strip of sod, leaving behind the newly exposed soil 19 and a roll of unwanted sod that is easy and convenient to move.

A singular garden maintenance tool for multipurpose use is described. The device has a handle, which may be short or elongated, which has a gripping end and a working end. The gripping end of the handle is covered with a soft material to improve a user's grip. The working end of the device is an irregular pentagonal blade having defined edges and an open interior space. The blade of the device has a shelf portion that attaches to the handle and two parallel cutting edges. The vertical cutting edges attach to a protruding V-shaped blade that constitutes the working tip of the blade. Serrated teeth that exist on the V-shaped blade, in conjunction with the two vertical cutting edges of the blade, enable the device to cut through plant roots, edge plant beds, cut strips of sod and cut back overgrowth of undesirable vegetation. Having a single device that serves a variety of gardening functions reduces the need to buy and store a plurality of single-function gardening tools. A further embodiment, as previously disclosed, incorporates only the top shelf and V-shaped cutting edges, which form an open central region without vertical cutting edges.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multifunctional garden and yard maintenance tool device, comprising:
a handle having a gripping end and a working end;
said working end attaching to a cutting blade;
said blade having a shelf region extending outward from said handle, side cutting edges aligned in parallel to each other and perpendicular from said shelf region, and two converging edges forming a V-shaped tip;
said blade edges forming an open interior space.

2) The device of claim 1, wherein said gripping end of said handle further comprises a soft material and a gripping ball for a user to grip during use.

3) The device of claim 1, wherein said converging edges of said V-shaped tip employ serrated teeth and a pointed tip.

4) The device of claim 1, wherein said converging edges of said V-shaped tip protrude out of plane from said shelf and side cutting edges into a three dimensional space.

5) A multifunctional garden and yard maintenance tool device, comprising:
a handle having a gripping end and a working end;
said working end attaching to a cutting blade;
said blade having a shelf region extending outward from said handle, and two converging edges forming a V-shaped tip;
said blade edges forming an open interior space.

6) The device of claim 5, wherein said gripping end of said handle further comprises a soft material and a gripping ball for a user to grip during use.

7) The device of claim 5, wherein said converging edges of said V-shaped tip employ serrated teeth and a pointed tip.

8) The device of claim 5, wherein said converging edges of said V-shaped tip protrude out of plane from said shelf into a three dimensional space.
